(19) United States
(12) Patent Application Publication
(10) Pub. No.: US 2002/0140626 A1
(43) Pub. Date: Oct. 3, 2002

(54) Display data transforming device

(75) Inventor: Jang-Li Chang, Taipei (TW)

Correspondence Address: GREENBLUM & BERNSTEIN, P.L.C., 1941 ROLAND CLARKE PLACE, RESTON, VA, 20191, US

(73) Assignee: SILITEK CORPORATION, Taipei (TW)

(21) Appl. No.: 09/881,713

(22) Filed: Jun. 18, 2001

(30) Foreign Application Priority Data
Mar. 30, 2001 (TW) 090107693

(51) Int. Cl. G09G 5/00

(52) U.S. Cl. 345/1.1

(57) ABSTRACT

The present invention provides a display data transforming device. The display data transforming device transforms display data of low resolution suitable for small display devices, such as personal digital assistants (PDA), into display data of high resolution suitable for display devices such as projectors and LCDs.

### FIELD OF THE INVENTION

The present invention relates to a display data transforming device.

### BACKGROUND OF THE INVENTION

Personal data processing devices, such as PDAs, mobile phones, electronic translators, have single-color or multicolor displays as part of the man-machine interface. However, owing to the small sizes and limited calculating capabilities of these personal data processing devices, resolution and dimensions of displays of these devices are lower and smaller than those of displays of normal desktop PCs or projectors. The state-of-art devices, such as some PDAs using Windows CE®, have resolution of 320×240 at best.

In single user scenarios, to view these small screens is trouble-free. Nevertheless, when more than two users intend to watch the screen at the same time, these users have to take turns or one of them has to transmit the display data to others' compatible personal data processing devices, so that every one could view the data. Take personal digital assistant (PDA) as an example, when everybody present has a compatible PDA in his hand, chance is that he can beam the target data to other PDAs. Upon receiving the data, users could activate applications to view it. Procedure like this works fairly well when only a few people present, under the premise that everyone has a compatible personal data processing device. When viewers increase and not all of them have an available and compatible personal data processing device, this procedure is impracticable.

Furthermore, when briefing of meeting, traditionally, a laptop is connected to a projector or some other large display devices, so that more people are able to view the briefing material synchronously. Along with the progress of semiconductor technology and the ever-increasing calculating capability of data processors, personal data processing devices, such as PDAs are ready to execute briefing software or store and show briefing material. Since personal data processing devices are small in size, if simply carrying a small personal data processing device will facilitate briefing and data presenting, the convenience is expectable.

However, the aforementioned problem regarding resolution is still inevitable. Desktop displays and projectors nowadays have resolution of 640×480 or higher. Even if the highest resolution of the personal data processing devices reaches 320×240, only one-fourth of the display area in the large display is occupied, thus degrading performance. If the resolution of the large display is set at 800×600 or 1024×768, the performance will be even degraded.

Therefore, a display data transforming device is required to transform display data of low resolution suitable for personal data processing devices into display data of high resolution suitable for projectors or other large display devices.

### SUMMARY OF THE INVENTION

In order to solve aforementioned problem regarding the low display data resolution, the present invention provides a display data transforming device. The display data transforming device receives first display data from a first display device (i.e. a personal data processing device) and, after processing of display data control circuit, transforms it into second display data suitable for a second display device, such as a CRT display device, an LCD display device, a plasma display devices or a projector. The resolution of the first display device is distinctly lower than that of the second display device.

### BRIEF DESCRIPTION OF THE DRAWINGS

FIG. 1 discloses the block diagram of a preferred embodiment of the present invention and connective relation among a personal data processing device, a large display device, and the device shown as a preferred embodiment.

### DETAILED DESCRIPTION OF THE INVENTION

Personal data processing devices from a variety of providers have many kinds of outputs and output data specifications. Taking a PDA for example, there are plenty kinds of outputs, such as an infrared transmitter (IrDA output), USB, and a RS232 port. Besides, memory expansion and slots for main memories, such as Compact Flash® slots, SmartMedia® slots, MultiMedia® slots, SD memory slots, Main Memory Interface (MMI) , and Memory Stick® slots are also good for connection. The outward connection of personal data processing device can be achieved by using connection lines compatible with one of these memory slots.

For simplicity, the display device of a personal data processing device is called the first display device. Compared with the first display device, a large (or larger) display device, such as a CRT display, an LCD display, a plasma display or a projector, is named after the second display device.

The present invention provides a display data transforming device. The display data transforming device transforms first display data from the output of the first display device into second display data suitable for the second display device. Wherein the first display data is display data of low resolution suitable for the first display device, and the second display data is display data of high resolution suitable for the second display device.

The display data transforming device comprises a display data input for connecting the output of the first display device, so as to receive the first display data; a display data output for connecting the second display device, so as to transmit the second display data to the second display device; and a display data control circuit for receiving the first display data from the display data input, transforming the first display data into the second display data, and transmitting the second display data to the display data output. The display data output then transmits the second display data to the second display device, so that the second display data is immediately shown or is stored in the memory of the second display device for later presentation.

As noted above, the output of the first display device can be an infrared transmitter (IrDA output), an USB, an RS232 port, a Compact Flash® slot, a SmartMedia® slot, a MultiMedia® slot, an SD memory slot, an MMI (main memory interface), and a Memory Stick® slot. The output of the first display device and display data input of the display data transforming device have the same or compatible specifications.

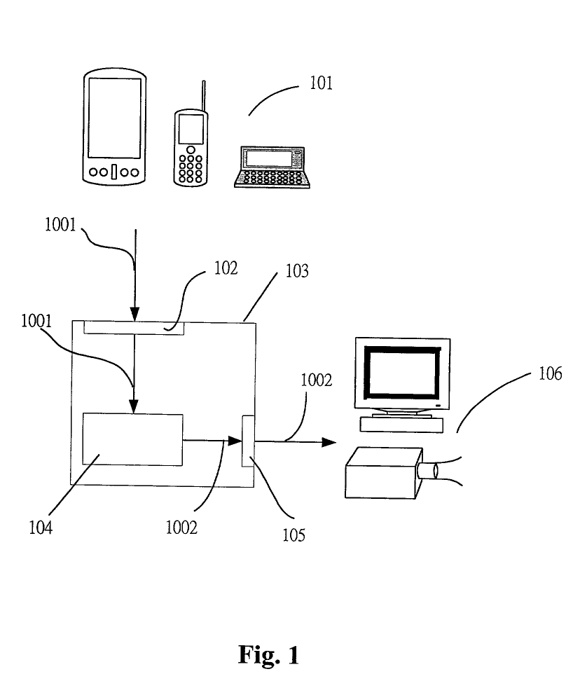

Referring now to FIG. 1, in the first preferred embodiment, the output (not shown) of the first display device 101 transmits first display data 1001 to the display data transforming device 103 by means of the connection with the display data input 102. Display data input 102 then transmits the first display data 1001 to a display data control circuit 104.

The display data control circuit 104 transmits the first display data 1001 received into the second display data 1002 suitable for the second display device 106, and transmits the second display data 1002 to the display data output 105. The display data output 105 then transmits the second display data 1002 to the second display device 106 for immediate display or store in behalf of later presentation. Even if the second display device 106 has no hardware or software compatible with the first display device 101, the second display device 106 still receives or stores the second display data 1002 without any difficulty. The preferred embodiment of the display data control circuit 104 is CY7C9335 produced by Cypress Inc.

As for how the display data control circuit 104 transforms the first display data 1001 to the second display data 1002, one of the examples is given below. If the resolution of the first display data 1001 is 320×240, and the resolution of the second display data 1002 is 640×480, then the later is four times larger than the former. One can map the coordinate (x, y) in the first display data 1001, to the coordinates (2x, 2y)-(2x−1, 2y)-(2x, 2y−1) and (2x−1, 2y−1) in the second display data 1002. One can also dither the second display data 1002. Persons skilled in the art have been acquainted with further processing of the second display data 1002.

In addition, the display data transforming device 103 may have a detecting device (not shown) that can automatically detect the resolution of the first display data 1001 and the second display data 1002. With the detecting device, one can transform display data appropriately according to the resolution on both kinds of data. The display data transforming device 103 may have a setting device (not shown). Users may set the resolution of the second display data 1002 using the setting device. Furthermore, the display data transforming device 103 may be equipped with a plurality of display data input or display data output for synchronous input, synchronous output, and co-display. All these and other permutation or modification will be apparent to those skilled in the art after reading the specification accompanied with figures.

It should also be noted that there are many alternative ways of implementing the apparatuses of the present invention. It is therefore intended that the following appended claims should be interpreted as including all such alternations, permutations, and equivalents as fall within the true spirit and scope of the present invention.

We claim,

1. A data transforming device for transforming first display data from an output of a first display device into second display data suitable for a second display device, wherein the resolution of said second display device is higher than the resolution of said first display device, said data transforming device comprising:
a display data input for connecting the output of said first display device, so as to receive said first display data;
a display data output for connecting said second display device, so as to transmit said second display data to said second display device; and
a display data control circuit for receiving said first display data from said display data input, transforming said first display data into said second display data and transmitting said display data to said display data output.

2. The data transforming device as depicted in claim 1, wherein said output of said first display device is an IrDA output and said display data input is an IrDA receiving port.

3. The data transforming device as depicted in claim 1, wherein both said output of said first display device and said display data input are USB ports.

4. The data transforming device as depicted in claim 1, wherein said output of said first display device is an RS232 port.

5. The data transforming device as depicted in claim 1, wherein both said output of said first display device and said display data input are Compact Flash® memory slots.

6. The data transforming device as depicted in claim 1, wherein both said output of said first display device and said display data input are Memory Stick® memory slots.

7. The data transforming device as depicted in claim 1, wherein both said output of said first display device and said display data input are SmartMedia® memory slots.

8. The data transforming device as depicted in claim 1, wherein both said output of said first display device and said display data input are MultiMedia® memory slots.

9. The data transforming device as depicted in claim 1, wherein both said output of said first display device and said display data input are SD memory slots.

10. The data transforming device as depicted in claim 1, wherein both said output of said first display device and said display data input are MMI.

11. The data transforming device as depicted in claim 1, wherein the resolution of said second display device is over 640×480.

12. The data transforming device as depicted in claim 1, wherein said second display device is a cathode ray tube display.

13. The data transforming device as depicted in claim 1, wherein said second display device is an LCD display.

14. The data transforming device as depicted in claim 1, wherein said second display device is a plasma display.

15. The data transforming device as depicted in claim 1, wherein said second display device is a projector.

16. A data display device comprising a data transforming device for transforming first display data from an output of an external display device into second display data suitable for said data display device, wherein the resolution of said data display device is higher than the resolution of said external display device, said data transforming device comprising:
a display data input for connecting the output of said external display device, so as to receive said first display data;
a display data output for connecting said data display device, so as to transmit said second display data to said data display device; and
a display data control circuit for receiving said first display data from said display data input, transforming said first display data into said second display data and transmitting said second display data to said display data output.

17. A data display device comprising a data transforming device for transforming first display data from an output of said data display device into second display data suitable for an external display device, wherein the resolution of said external display device is higher than the resolution of said data display device, said data transforming device comprising:
a display data input for connecting the output of said data display device, so as to receive said first display data;
a display data output for connecting said external display device, so as to transmit said second display data to said external display device; and
a display data control circuit for receiving said first display data from said display data input, transforming said first display data into said second display data and transmitting said second display data to said display data output.
